(19) United States
(12) Patent Application Publication
(10) Pub. No.: US 2026/0183718 A1
(43) Pub. Date: Jul. 2, 2026

(54) SYSTEM AND METHOD FOR IMPROVED MICRO AND ULTRA CROSSFLOW MEMBRANE FILTRATION

(71) Applicant: PurposeEnergy LLC, Windham, NH (US)

(72) Inventors: James V. Banks, Harvard, MA (US); Eric E. Fitch, Windham, NH (US); Bryan M. Dwyer, Burlington, VT (US)

(73) Assignee: PurposeEnergy LLC, Windham, NH (US)

(21) Appl. No.: 19/006,949

(22) Filed: Dec. 31, 2024

(51) Int. Cl. B01D 65/02; B01D 61/14

(52) U.S. Cl. CPC B01D 65/02; B01D 61/14; B01D 2313/18; B01D 2313/19; B01D 2315/10; B01D 2317/02; B01D 2321/04; B01D 2321/12; B01D 2321/168; B01D 2321/40

(57) ABSTRACT

The present invention is an improved system and method of crossflow microfiltration and ultrafiltration with a membrane that is subject to fouling during the filtration process. The system includes a permeate removal conduit for transferring permeate. The permeate removal conduit includes a flexible orifice arranged by flexing and contracting to regulate permeate flow through each membrane module and thereby regulating membrane flux through each membrane in the system. The system also includes a backpulse check valve to enhance delivery of backpulse and membrane cleaning fluids.

### BACKGROUND OF THE INVENTION

### 1. Field of the Invention

The present invention relates to fluid microfiltration and ultrafiltration using crossflow membrane technology. Specifically, the invention relates to improvements to systems for microfiltration and ultrafiltration that address membrane fouling. The improvements reduce the impact of fouling while also enabling continuous monitoring of transmembrane pressure across each filter element.

### 2. Description of the Prior Art

There currently exists systems and methods for filtering a solution with one or more permeable membranes in order to selectively retain portions of the contents of the feed solution. Such systems typically include one or more modules, with each module including at least one permeable membrane. The module also includes a housing, conduit, or other means for transporting the solution to be filtered through the membrane that is within the conduit. The module includes at least an inlet port for receiving from a source the solution to be filtered, a first outlet for delivering from the conduit a first portion of the solution contents that does not pass through the membrane, and a second outlet for delivering from the conduit a second portion of the solution contents that does pass through the membrane.

In an example filtration system with a single cross-flow filter module, the solution, which may also be referred to herein as a feed, passes through the module inlet into the conduit of the filter module. The solution then makes contact with the membrane or membranes of the filter module. In a cross-flow filtration system, the membrane or membrane set is positioned parallel to the flow of the solution so that the second portion of the solution crosses the direction of solution flow to pass through the membrane. The first portion of the solution that does not pass through the filter may be referred to as the retentate or concentrate, and the second portion of the solution that passes through the membrane to the second outlet may be referred to as the permeate. It is noted that filtration systems, including microfiltration and ultrafiltration processes, may employ a single membrane module or a set of modules, which may be coupled in series to one another such that the first outlet of one module is coupled to the inlet of a following module. In that way, each success module should filter smaller and smaller portions of permeate to render the retentate at the end of the chain of modules as highly concentrated as possible.

The movement of unfiltered feed into the module and subsequent movement of the retentate and the permeate out of the module creates several different fluid pressures that impact the viability and effectiveness of the filtration effort. The pressures generated during filtration include a feed pressure, a retentate pressure, and a permeate pressure. Simply stated, the feed pressure may be measured at our near the inlet of the module, the retentate pressure may be measured at or near the first outlet, and the permeate pressure may be measured at or near the second outlet. As membrane fouling occurs such that membrane pores become clogged, fluid flow is reduced, and process inefficiencies occur. The extent of fouling can be estimated by examining flow rate as a function of feed temperature, inlet, outlet, and permeate pressures.

Transmembrane pressure (TMP) is a calculated representation of inlet, retentate, and permeate pressures and is used in the filtration industry along with feed temperature and permeate flux to identify the possible existence of membrane clogging. The TMP calculation uses the mean of applied pressure from the feed to the retentate side while accounting for line pressure of the permeate side. More specifically, the TMP is calculated by averaging the line pressure between the feed side and the retentate side and subtracting the line pressure on the permeate side. That is, TMP measures the net driving force applied to the membrane filtration. For a given feed stream and temperature, an optimal TMP exists for each membrane module such that each membrane's sustainable permeate flux is not exceeded. Membrane modules operating above the optimal TMP, will initially experience higher permeate flux that can be sustained and thereby will experience premature fouling. Membrane modules operating below the optimal TMP, will experience lower than optimal productivity (permeate flux). Each of these actions reflect reduced system efficiency as membrane fouling requires a halt to the filtration process followed by a membrane cleaning operation that is intended to reverse membrane fouling. The higher the TMP, the greater the need for an increase in pressure of the feed passing into the module to force permeate through the membrane. Increased TMP typically has a diminishing return as the foulant collecting upon the membrane's surface are compressed and further reduces permeate rates. The overall effect is that higher TMP increases the rate of membrane fouling which increases the frequency of membrane cleaning. Membrane cleaning operations requires a halt to the filtration process, which is an undesirable condition.

Membrane fouling is a condition in which particles, colloids, and molecules from the feed stream accumulate upon the membrane surface and eventually become lodged around the membrane pores, reducing the effectiveness of the filtration by the membrane. Membrane fouling can lead to reduced permeate flow, increased TMP, and potential for undesired rejection of solutes by the fouled membranes as well as excessive operating run times due to the reduction in permeate rate. Membrane fouling may require cleaning through backwashing, chemical cleaning, or other methods. Severe membrane fouling may require membrane replacement. All such steps will slow or halt the filtration process.

The current practice is for microfiltration and ultrafiltration systems to manage a specific TMP to ensure less than optimal performance. Typically, the feed and retentate pressures are held at steady levels while permeate backpressure may or may not be actively managed to regulate TMP. In multi-element systems where the permeate backpressure is not actively managed, TMP will vary between elements resulting in loss of optimal performance of most elements. For elements operating above the optimal TMP, initial permeate rates can exceed the optimal rate resulting in higher rates of fouling. Conversely, elements operating below the optimal TMP may underperform as the element's lower TMP results in lower permeate rates. An increase in effective filtration TMP (differential pressure) can hasten membrane fouling, reduce long-term performance of the membrane, and may result in irreversible loss of membrane performance. Active management of permeate backpressure is typically achieved by (1) installing a self-contained pressure reducing valve in each permeate line; (2) installing a fixed, rigid, orifice plate in each permeate line; or (3) installing a modulating valve with an upstream pressure sensor and pressure controller.

There currently exists methods of cleaning or reducing membrane fouling. One such common method is backpulsing the filtration membranes. Backpulsing is a physical method which can reduce membrane fouling by reversing the flow of permeate and thereby disrupt the gel polarization layer which forms on the membrane surface. In this method, a solution is flushed back through the membrane by reversing the TMP, working to dislodge material accumulating on the membrane surface and along the membrane pores. Existing methods of permeate backpressure management limit the methods in which membrane fouling may be treated. In the permeate backpressure management methods identified herein, methods (1) and (2) either reduce the effectiveness or eliminate backpulsing entirely as a method of reversing or retarding membrane fouling. As for method (3) listed above, backpulsing is possible, but may be expensive or difficult to implement for each membrane module in a set of modules, particularly when the filtration system is employed as part of an anaerobic membrane reactor system, which is characterized by high volumetric throughput and high solids loading.

With current filtration systems, backpulsing may be costly, ineffective, or both, dependent on the solution to be filtered and the desired concentrate outcome. What is needed is a system and method to improve microfiltration and ultrafiltration in a filtration system with a crossflow membrane configuration. More particularly, what is needed is an improved filtration the disruption of the gel polarization layer and removal of accumulated materials from the membrane pores. The above attributes become increasingly important in applications such as anaerobic membrane reactor systems that typically have high solids loading and high volumetric flow rates requiring many membrane modules arrayed in series. What is further needed is an improved filtration system which actively limits permeate flux for each membrane module and an operating method arranged to sense and to monitor temperature and pressures for the leading indicators of membrane fouling, and proactively reversing the fouling through periodic permeate backpulse functions. Further, to minimize the impact of membrane fouling by proactively cleaning-in-place the membranes using a similarly efficient membrane cleaning functions.

### SUMMARY OF THE INVENTION

A goal of the present invention is to provide an improved filtration system and method for microfiltration and ultrafiltration to facilitate and manage high-sustainable flux for each membrane module installed within the system. When a plurality of membrane modules exist, the plurality of modules typically exist in a series array whereby each element operates at different feed and retentate pressures. To ensure this improved system operates at high efficiency, the system includes flexible orifice(s) installed within the permeate output of each membrane module. Each flexible orifice is selected for a specific maximum flow rate. This feature enables each module to operate within specified limits and substantially at a constant flux regardless of the changes in operating pressures found throughout multi-module systems.

Another goal of the present invention is to provide an improved filtration system and method arranged to manage backpressure control during backpulsing efforts used to disrupt membrane fouling mechanisms for systems containing a single membrane module or a plurality of membrane modules. The system includes a check valve between a backpulse source and the permeate output in parallel with the flexible orifice. The check valve is oriented to permit flow in the opposite direction to the flow normally regulated by the flexible flow orifice device. Each membrane module may include such a check valve to achieve this goal.

It is also a goal of the present invention to provide an improved filtration system and method arranged to manage backpressure control during backpulsing efforts by optionally sensing pressure associated with the permeate output and using the sensed information to initiate backpulsing activity. That is, the system optionally includes a pressure sensor on the permeate output, located between the membrane module outlet and the flow control device of each membrane module, to detect pressure conditions for each module rather than simply from the feed input to a final common permeate output and/or final common retentate output. When a membrane begins to foul during the filtration process, permeate backpressure, measured at these pressure sensing locations, will drop below specific target values. When other conditions are constant, monitoring the rate of change for permeate pressure at the module(s) will indicate the need to backpulse the membranes to prevent or slow membrane fouling. The monitoring of permeate pressure at each module's permeate output may help to indicate the need to backpulse the membrane exhibiting possible clogging to prevent or slow membrane fouling. This can be done for each membrane so that it is only necessary to maintain that specific membrane rather than checking all membranes in a multipass set to discover which one(s) require maintenance. The pressure sensors may be coupled to one or more controllers to allow for the adjustment of temperature and pressure effects on permeate flow. A plurality of modules may be ganged together as part of a comprehensive filtration system.

During filtration, the feed is directed from a source through the membrane module by applied pressure, such as by a pump. As noted, the module includes a conduit and a membrane within the conduit. The conduit includes an input, a first output for retentate delivery and a second outlet for permeate delivery. The membrane in the module is selected to separate retentate of the feed solution from permeate of the feed solution, wherein the solution feed that is retentate rich continues to pass through the filtration system. When the filtration system includes a plurality of modules coupled together in series, the operating feed and retentate pressure of each successive module is reduced.

Typically for systems containing a single common point of permeate pressure control, the TMP associated with the first module of the system, the one that receives the original feed solution, is greatest with the TMP for each successive module being reduced incrementally. This operating condition leads to a mechanism of membrane fouling as the first modules in the array, operating at relatively higher TMP, experience higher than optimal flux and thereby foul at a higher than optimal rate. Once fouling occurs, higher flux is needed by the downstream membrane elements and thereby resulting in their premature fouling. The present invention improves management of the tangential flow filtration process by configuring each membrane module with a flexible orifice device that limits permeate flow to a pre-configured rate and thereby limiting each membrane module to a maximum, pre-defined membrane flux. These flexible orifice devices limit permeate flow rate from each module independent of the operational feed and retentate pressure found throughout the filter system.

Further improvement of the permeate flow management occurs when a check valve device is installed hydraulically in parallel to the flexible orifice device and is configured to permit backpulse fluid to pass into the permeate-side of the module in the direction opposite to the normal permeate flow direction (when in production). This configuration permits the operators of the filtration system to backpulse the membrane modules at desired flows and pressures.

Any alternate to the above further improvement whereby permeate is removed using the flexible flow orifice at a controlled rate from one permeate port and permeate backpulse is added through the check valve through the second permeate.

The flexible orifice(s) and check valve of the membrane module with which it is associated is selected and configured to enable the system to compensate for varying transmembrane pressures (TMPs), encountered when operating a system containing multiple membrane modules, as well as to facilitate backpulsing as a method of cleaning, restoring, or retarding fouling of the membrane. Because the permeate backpressure requirements vary for each membrane module, the flexible orifice provides a constant flow rate with varying permeate pressure because of the orifice material flexibility. One example of a suitable membrane module is the Permaflux™ V10XL module with tubular membrane available from Thetis Environmental of Hamilton, Ontario, Canada. Another example membrane module suitable for the present invention is the tubular UF module model MO 104G_I8LE XLV available from Berghof Membrane Technology GmbH of Eningen, Germany. The Berghof membrane module includes the model 66.03 i8LE tubular membrane. The membrane is made of a non-metallic material, such as PTFE but not limited thereto, having a flexibility greater than the flexibility of a metal membrane. Other membrane modules with similar functionality may be used for the system of the present invention.

The check valve is oriented to selectively regulate fluid flow in a single direction. That is, permit substantially unrestricted flow of backpulse solution into the permeate conduit (opposite to the flow direction of the flexible orifice) to dislodge material prone to fouling the membrane. Specifically, when backpulsing is desired, the membrane system is configured to reduce the membrane modules'feed pressure while allowing material from the membrane's feed be displaced from the membrane separation surface as the higher pressure backpulse fluid passes from the permeate-side to the feed-side of the membrane. When the backpulse solution valve is closed and normal operating feed pressure is restored, the permeate flows out of the permeate conduit, through the flexible orifice and into a common permeate output conduit. When the backpulse solution valve is open, pressurized backpulse fluid is forced into the permeate conduit for reverse flow back through the membrane and permeate flow into the permeate removal conduit is halted. One example of a suitable check valve and use for the present invention is identified on the schematic. An example of the check valves is model number FPJPVBN.500SST available from the Check-All Valve Manufacturing Company of West Des Moines, Iowa. Another check valve having functionality similar to the example may be used to carry out the functions of the check valve of the system of the present invention.

The invention is summarily described as a filtration system including a feed pump, a feed conduit, including a system inlet valve, a system reject valve, and a feed side vent valve. It further includes a membrane module including an interior space and a filtration membrane, wherein the membrane module includes an inlet coupled to the feed conduit, a permeate output, containing one or more permeate conduits coupled to the membrane module and arranged to transport permeate passing from the interior space through the filtration membrane, wherein the permeate output conduit(s) are split into a permeate removal conduit and a permeate backpulse conduit, a flexible orifice, whose flow rate performance is selected to limit the maximum permeate flux for the membrane module, and is positioned inline in the permeate removal conduit, a backpulse check valve positioned in the permeate backpulse conduit, and an integrated control system to enable periodic cycling between filtration and backpulse functions. The system may include a plurality of membrane modules coupled together in series. Each flexible orifice is selected to restrict permeate at a substantially constant flow rate over a range of operating pressure differentials in response to variable operating pressures within one or more of the conduits. The check valve is used to selectably regulate backpulse fluid flow direction while conveying fluid flow in the permeate conduit at a flow rate and pressure that is not restricted by the module's permeate flow orifice. The system may also include one or more pressure sensors arranged to sense pressure within one or more of the conduits. When the system includes two or more membrane modules, flexible flow orifice flow rate selections are optimized for increased feed and retentate concentrations as permeate is removed from the successive upstream membrane modules. The pressure and flow rate of the fluid for backpulse is generated using an independent pump. It is noted that the backpulse fluid may be replaced with a clean-in-place solution, thereby enabling the membranes contained within the modules to be cleaned through the introduction of clean-in-place fluid by introduction of backpulse fluid. Both backpulsing and membrane cleaning within the modules may be provided by a clean-in-place solution. The system may also include one or more tangential flow membrane modules, each of which includes a feed inlet, a retentate outlet, and a permeate outlet.

The invention is also characterized as a system for disrupting a layer of membrane foulant on a membrane of one or more membranes of one or more membrane modules from a surface of the membrane of a filtration system. That system includes a feed conduit, a feed pump and a means of regulating the feed pump's speed, a system inlet valve and a means of transitioning the system inlet valve from open to closed and closed to open, a system reject valve and a means of transitioning the system reject valve from open to closed and closed to open, a system feed side vent valve and a means of transitioning the system feed side vent valve from closed to open and open to closed, and an integrated control system to enable periodic cycling between filtration and backpulse functions. The inlet valve, the feed pump, the feed side vent valve, the one or more membrane modules, and the system reject valve may be coupled to the membrane modules in series using feed and retentate conduits. Each of the one or more membrane modules includes an interior space and a filtration membrane, wherein the membrane module includes an inlet coupled to the feed conduit, and wherein a permeate output conduit coupled to the membrane module and arranged to transport permeate passing from the interior space through the filtration membrane, wherein the permeate output conduit is split into a permeate removal conduit and a permeate backpulse conduit.

The invention further includes a method of disrupting a layer of membrane foulant on a membrane of one or more membranes of one or more membrane modules from a surface of the membrane of a filtration system, wherein the system includes a feed conduit, a feed pump and a means of regulating the feed pump's speed, a system inlet valve and a means of transitioning the system inlet valve from open to closed and closed to open, a system reject valve and a means of transitioning the system reject valve from open to closed and closed to open, a system feed side vent valve and a means of transitioning the system feed side vent valve from closed to open and open to closed, an integrated control system to enable periodic cycling between filtration and backpulse functions, wherein the inlet valve, the feed pump, the feed side vent valve, the one or more membrane modules, and the system reject valve are coupled to the membrane modules in series using feed and retentate conduits, and wherein each of the one or more membrane modules includes an interior space and a filtration membrane, wherein the membrane module includes an inlet coupled to the feed conduit, and wherein a permeate output conduit coupled to the membrane module and arranged to transport permeate passing from the interior space through the filtration membrane, wherein the permeate output conduit is split into a permeate removal conduit and a permeate backpulse conduit. The method includes the steps of inserting a flexible orifice positioned inline in the permeate removal conduit, inserting a backpulse check valve in the permeate backpulse conduit, and periodically backpulsing the membrane modules by slowing or stopping the feed pump, closing the system inlet valve, closing the system reject valve, opening the feed side vent valve, and enabling pressurization of backpulse fluid to permit backpulsing to occur at a desired flow rate and duration within one or more of the conduits. The method may further include the steps of disabling the delivery of backpulse fluid to the one or more membrane modules, closing the feed side vent valve, opening the system reject valve, opening the system inlet valve and operating the feed pump at its desired speed. The method may also include the use of a timer or series of timers as well as logic-based monitoring associated with one or more of the conduits with one or more pressure sensors for the purpose of initiating the membrane backpulse function, and monitoring system temperature and the rate of change at permeate backpressure(s) at one or more membrane modules to evaluate the need to initiate the membrane backpulse function.

During the filtration operation, the system may be operated at an elevated initial feed at a first membrane module pressure and final retentate at a last membrane module pressure to ensure that sufficient pressure drop exists across each flexible flow orifice to allow each flexible orifice to operate substantially near its maximum desired flow rate. The elevated initial feed at the first membrane module pressure is attained by the sum of the feed pump inlet pressure and the pressure generated by the feed pump's operation while the final retentate at the last membrane module pressure is attained by the feed pump inlet pressure alone. The backpulse fluid may be replaced with clean-in-place solution and thereby enabling the membranes contained within the modules to be cleaned through the introduction of clean-in-place fluid. Monitoring may be included for system pressures within one or more of the conduits with one or more pressure sensors for the purpose of initiating the membrane cleaning function. Monitoring may be included for system temperature and the rate of change at permeate backpressure at one or more membrane modules to evaluate the need to initiate the membrane cleaning function. The membrane backpulse function and/or the cleaning function may be initiated based upon time.

### BRIEF DESCRIPTION OF THE DRAWINGS

FIG. 1 is a cross-sectional representation of a first embodiment of a filtration system of the present invention comprising one membrane module for filtration.

FIG. 2 is a representation of a second embodiment of the filtration system of the present invention comprising a plurality of membrane modules in series for filtration.

FIG. 3 is a close-up perspective side view of a plurality of membrane modules and check valves of an example multi-module system of the invention with module and check valve pairs and associated conduits are in parallel.

FIG. 4 is a perspective top view of the multi-module system of FIG. 3 in a container box including conduit units with associated membrane modules and check valves. FIG. 4A is a detailed view of a section of the system of FIG. 4.

### DETAILED DESCRIPTION OF THE INVENTION

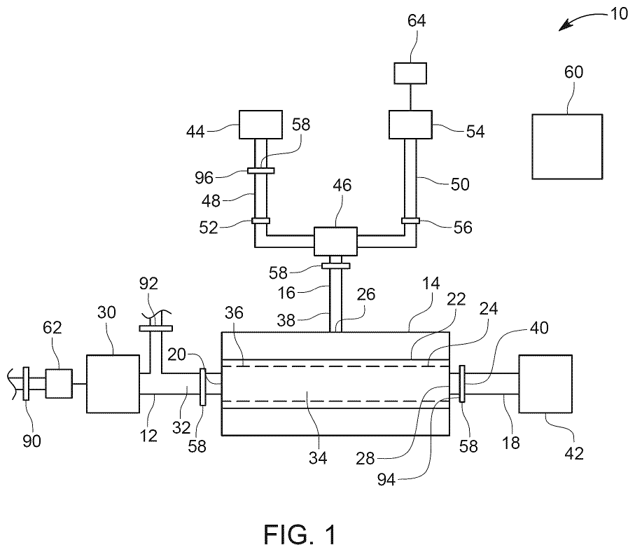

A first embodiment of a filtration system 10 of the present invention is shown in FIG. 1. The filtration system 10 includes a feed conduit 12, a membrane module 14, a permeate output conduit 16, and a retentate output conduit 18. The membrane module 14 includes a module inlet 20, a porous filtration housing 22, a filtration membrane 24, a permeate outlet 26, and a retentate outlet 28. The feed conduit 12 couples a source 30 of a feed solution 32 to be filtered to the membrane module 14 via the module inlet 20. The porous filtration housing 22 includes an interior space 34 and an inner surface 36 configured to enable passage of permeate 38 of the feed solution 32 through the housing 22 to the permeate output conduit 16 via the permeate outlet 26. The filtration membrane 24 is a microfiltration or ultrafiltration membrane selected and configured to permit the permeate 38 to pass to the permeate outlet 26 and prevent retentate 40 from passing into the permeate outlet 26. Instead, the retentate 40 moves through the interior space 34 to the retentate output conduit 18 through the retentate outlet 28 of the membrane module 14 where it is transported to a retentate storage container 42.

With continuing reference to FIG. 1, the filtration system 10 further includes a permeate storage container 44 for receiving the permeate 38 from the membrane module 14. The permeate outlet conduit 16 is split at joint 46 into a permeate removal conduit 48 and a permeate backpulse conduit 50. The permeate removal conduit 48 is coupled to the permeate storage container 44. A flexible orifice 52 is positioned inline between the joint 46 and the permeate storage container 44 such that the permeate 38 first passes through it before entering the permeate storage container 44. The flexible orifice 52 provides a mechanism to regulate the maximum permeate flow from the membrane module 14 by expanding or contracting dependent on pressure within the permeate outlet conduit 16. The ability to regulate near constant permeate flow rate over a range of pressures at permeate outlet conduit 16 is of greatest importance when the filtration system contains a plurality of membrane modules operated in series. In such instances, operating pressures for the feed solution 32 and retentate 40 at each filter module 14 is reduced. Each of these reductions changes the operating pressure at each module's permeate outlet conduit. By locating flexible flow orifice 52 within each module permeate outlet conduit 16, a maximum permeate rate per module (membrane flux) can be established and controlled for all membrane modules.

The permeate backpulse conduit 50 is coupled to a backpulse fluid source 54, which source 54 is used to backpulse and flush the filtration membrane 24. A backpulse check valve 56 is joined in series between the joint 46 and the backpulse fluid source 54. The backpulse check valve 56 provides a mechanism to apply backpulse fluid at a higher flow rate and pressure than what would be possible when backpulsing (reverse flow) through flexible orifice 52. The efficacy of the backpulse function is improved through the ability to convey backpulse solution through backpulse check valve 56 and joint 46 while and by-passing flexible orifice 52.

The filtration system 10 further includes one or more pressure sensors 58 for sensing pressure at one or more of the module inlet 20, the permeate outlet 26, and the retentate outlet 28. The pressure sensors 58 are coupled to a controller 60. The controller 60 is selected and configured to gather sensor information, determine a potential for TMP that is out of a selectable desired range, and output instruction for modification of operation of a feed pump 62, a backpulse source pump 64, system inlet valve 90, system reject valve 94, and feed-side vent-to-drain valve 92. The backpulse check valve 56 uses either gravity or a spring to ensure that flow occurs in a single, desired direction automatically. Regulation of one or more of the feed pump 62, the backpulse source pump 64, the system inlet valve 90, the system reject valve 94, and the feed-side vent-to-drain valve 92 with the controller 60 allows the user to address fouling of the membrane 24 before such fouling redarns the filtration system 10 undesirably inefficient or inoperable.

The flow of the solution feed through the system 10 is determined by various pressures that exist throughout the system 10. Those pressures include a feed pressure that can be detected at location 20, a permeate backpressure (that is the location typically used when calculating TMP) can be detected at location 26, a retentate pressure that can be detected at location 28, a resulting permeate downstream pressure (that is typically used when calculating pressure drop across the flexible orifice) can be detected at location 96, and a transmembrane pressure calculated by using the mean of the applied differential pressure from the feed pressure to the retentate pressure subtracted by the permeate backpressure at location 26. The feed pressure is the pressure of the feed solution 32 at the membrane module inlet 20. The permeate backpressure is the pressure of the permeate 38 exiting the membrane module 14 at location 26. The retentate pressure is the pressure of the retentate 40 exiting the membrane module 14 at location 28. The backpressure is the pressure of the permeate 38 back on the membrane module 14. Typical flow during filtration consists of the feed pressure exceeding the permeate backpressure to result in the feed solution 32 passing through the membrane module 14 to generate the permeate 38 and retentate 40.

The pressures of the system 10 may be changed and system valve states changed whereby the system inlet valve 90 transitions from open to closed, the system reject valve 94 transitions from open to closed, and the feed-side vent-to-drain valve 92 transitions from closed to open allowing flow to reverse using the check valve 56, resulting in the permeate backpressure exceeding the feed pressure. This change in directional flow results in a solution being passed through the permeate output conduit 16, the permeate outlet 26, the membrane module 14, the housing 22, the filtration membrane 24, and the inner surface 36 to the interior space 34. Reversing the flow in this method is the backpulsing and is used as a method of disrupting the concentration of materials upon the surface of the membrane 24 or membrane module(s) 14 to prevent, limit, or reverse membrane fouling. A clean-in-place solution may be used as a substitute for the backpulsing fluid as a way to enhance membrane clearing.

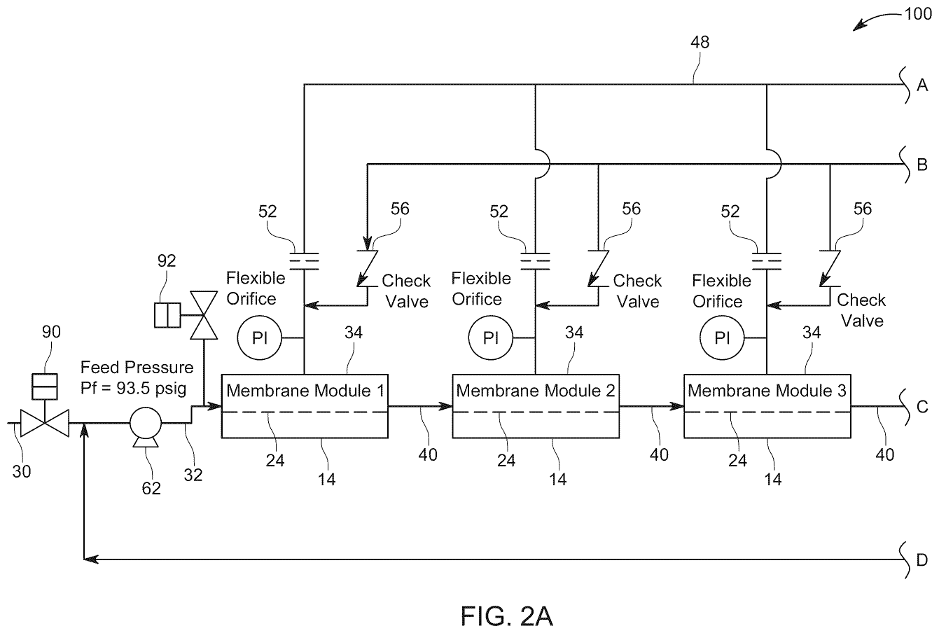

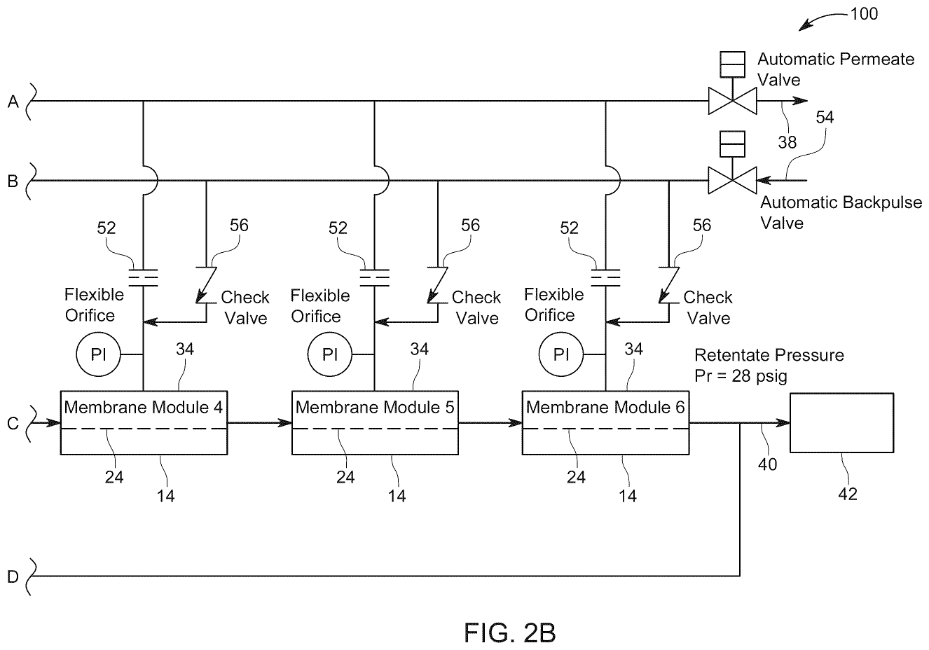

As depicted in FIG. 2, a second embodiment of a filtration system 100 of the present invention includes a plurality of membrane modules 14 coupled together in series. Each of the plurality of membrane modules 14 filters the feed 32 that enters it, starting with the source 30 for the first membrane module 14 in the series, and each subsequent module 14 receiving its feed 32 from the membrane module 14 that precedes to produce a unique composition of the permeate 38 and a unique composition of the retentate 40 from each membrane module 14. The permeate outputs of each module 14 are collected together while the retentate 40 from the final module of the series is the final output produce of the filtration system 100. Each module includes its own check valve 56, which provides a method of reversing the directional flow from the backpulse fluid source 54 to the interior space 34 for that respective module 14. The reversal of the flow, enabled by the check valve 56, allows for backpulsing of the membrane 24 as a method of cleaning or retarding membrane fouling. It is noted that in an alternative embodiment of the invention, there may not be a check valve 54 associated with each module 14. As noted, the backpulse fluid source 54 may be a cleaning solution used to perform clean-in-place function.

In addition, each module 14 includes a flexible orifice 52 in line for each permeate removal conduit 48. In an alternative embodiment, each module 14 includes a flexible orifice for a single permeate removal conduit 48 and check valve 56 in communication with a backpulse source for one or more permeate removal conduit 48. In an alternative embodiment, one or more of the modules 14 of the system 100 may not include an inline flexible orifice 52. In backpulsing, the flow of solution is reversed. The check valve 56 enables substantially unrestricted flow from the backpulsing fluid source 54 into the interior space 34 by way of the permeate backpulse conduit 50, the joint 46, the permeate output conduit 16, the permeate outlet 26, the membrane module 14, the porous filtration housing 22, and the filtration membrane 24. During backpulsing, the pressure measured at the permeate pressure location 26 exceeds that of the pressure measured at the feed pressure location 20 forcing the solution through the filtration membrane 24 and inner surface 36 as a method of cleaning in place the membrane 24 by disrupting the layer of accumulated materials from the membrane's separation surface 36. A cleaning solution may be used for that purpose. In an alternative embodiment, the feed source and retentate storage container 42 are one and the same units. In an alternative embodiment, the retentate 40 stream is split whereby a fraction of the retentate flow is recycled to the feed pump 62 inlet and the balance is returned to the retentate storage container 42.

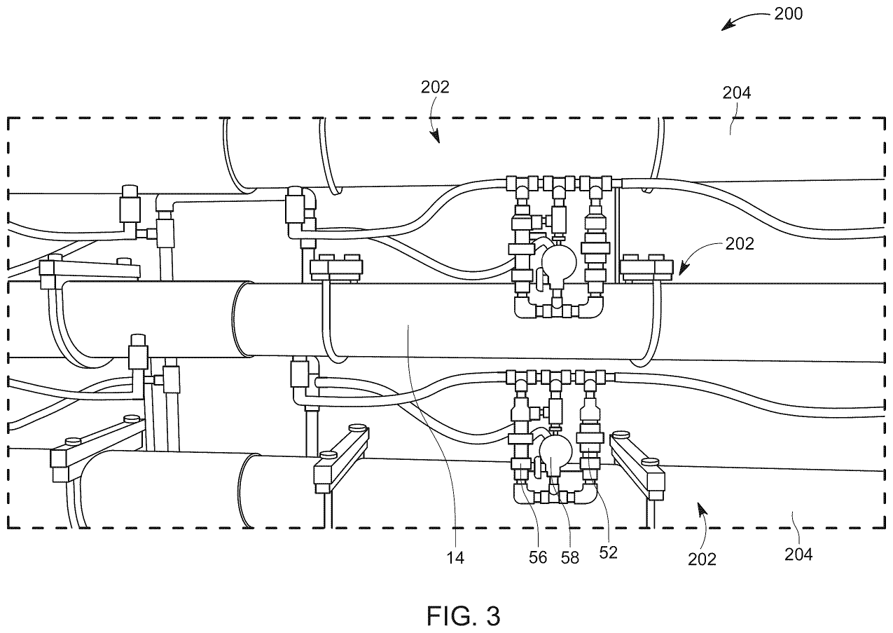

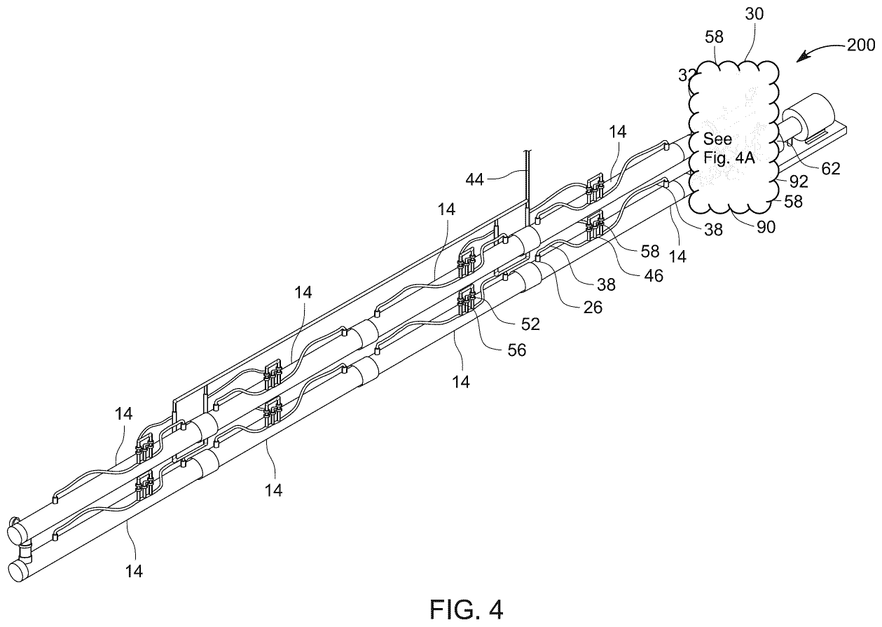

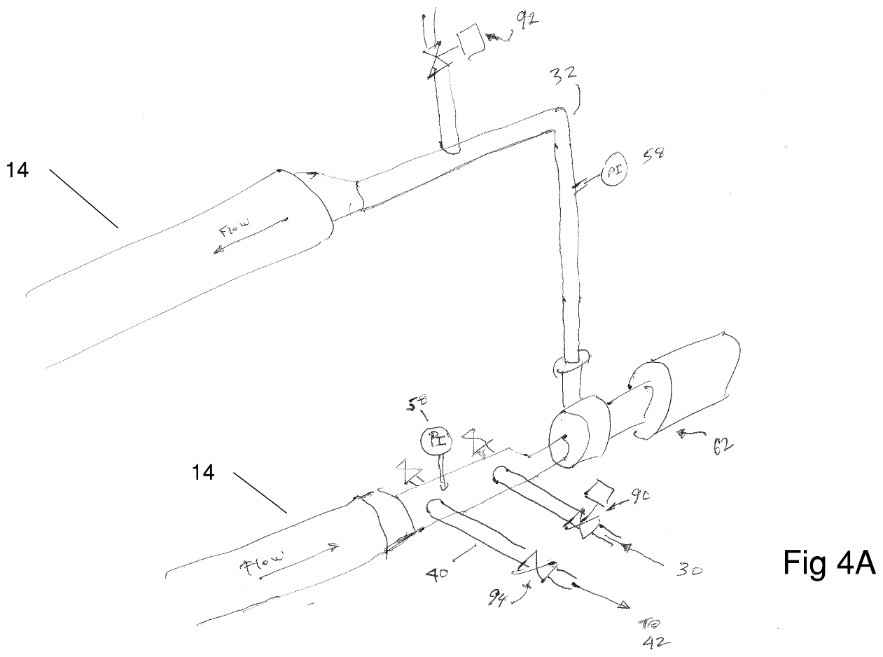

FIGS. 3, 4, and 4A illustrate a filtration system 200 including a plurality of membrane modules 14, wherein each membrane module 14 functions in series with other membrane modules 14. FIGS. 4 and 4A specifically shows a filtration system 200 containing eight membrane modules 14 in series with one another for filtration. Other numbers of membrane modules 14 may be used. Each membrane module 14 includes a conduit for source 30, feed solution 32, retentate 40, retentate storage 42 and permeate 38 exiting the membrane module 14 at location 26. The check valve 56 and the flexible flow orifice, both of which operate in the manner described herein. In the example of FIGS. 4 and 4A with eight membrane modules, the first membrane module is daisy-chained to a second membrane module, which is in turn daisy-chained to a third membrane module, which is in turn daisy-chained to a fourth membrane module, which is in turn daisy-chained to a fifth membrane module, which is in turn daisy-chained to a sixth membrane module, which is in turn daisy-chained to a seventh membrane module, which is in turn daisy-chained to an eighth membrane module, with a portion of the retentate 40 returning to the pump 60 inlet. Backpulse and clean-in-place components as described herein are provided for each membrane module 14 which enable backpulsing and cleaning for all four filtration units. In this example embodiment of the invention, all eight membrane modules are in filtration, backpulse, or clean-in-place mode at the same time. The controller enables selection, including the option of manual selection, of which mode (filtration, backpulsed, or cleaned-in-place) at any one time. The system 200 shown in FIGS. 4 and 4A may operate alone, or with two or more filtration systems operating in parallel.

The present invention has been described with reference to specific configurations. It is only intended to be limited to the description set out in the claims and equivalents.

What is claimed is:

1. A filtration system comprising:
a feed pump;
a feed conduit, including a system inlet valve, a system reject valve, and a feed side vent valve;
a membrane module including an interior space and a filtration membrane, wherein the membrane module includes an inlet coupled to the feed conduit;
a permeate output, containing one or more permeate conduits coupled to the membrane module and arranged to transport permeate passing from the interior space through the filtration membrane, wherein the permeate output conduit is split into a permeate removal conduit and a permeate backpulse conduit;
a flexible orifice, whose flow rate performance is selected to limit the maximum permeate flux for the membrane module, and is positioned inline in the permeate removal conduit;
a backpulse check valve positioned in the permeate backpulse conduit;
where the permeate removal conduit operates in the opposite flow direction, but in parallel with the permeate backpulse conduit; and
an integrated control system to enable periodic cycling between filtration and backpulse functions.

2. The system of claim 1 wherein the filtration system includes a plurality of membrane modules coupled together in series.

3. The system of claim 1 wherein each flexible orifice is selected to restrict permeate at a substantially constant flow rate over a range of operating pressure differentials in response to variable operating pressures within one or more of the conduits.

4. The system of claim 1 wherein the check valve is used to selectably regulate backpulse fluid flow direction while conveying fluid flow in the permeate conduit at a flow rate and pressure that is not restricted by the module's permeate flow orifice.

5. The system of claim 1 further comprising one or more pressure sensors arranged to sense pressure within one or more of the conduits.

6. The system of claim 1 containing two or more membrane modules whereby flexible flow orifice flow rate selections are optimized for increased feed and retentate concentrations as permeate is removed from the successive upstream membrane modules.

7. The system of claim 1 whereby the pressure and flow rate of the fluid for backpulse is generated using an independent pump.

8. The system of claim 1 whereby backpulse fluid is replaced with clean-in-place solution and thereby enabling the membranes contained within the modules to be cleaned through the introduction of clean-in-place fluid using the backpulse fluid flow path.

9. The system of claim 1 whereby both backpulsing and membrane cleaning within the modules are provided by a clean-in-place solution.

10. The system of claim 9 further comprising one or more tangential flow membrane modules, each of which includes a feed inlet, a retentate outlet, and a permeate outlet.

11. A system for disrupting a layer of membrane foulant on a membrane of one or more membranes of one or more membrane modules from a surface of the membrane of a filtration system, the system comprising:
a feed conduit;
a feed pump and a means of regulating the feed pump's speed;
a system inlet valve and a means of transitioning the system inlet valve from open to closed and closed to open;
a system reject valve and a means of transitioning the system reject valve from open to closed and closed to open;
a system feed side vent valve and a means of transitioning the system feed side vent valve from closed to open and open to closed; and
an integrated control system to enable periodic cycling between filtration and backpulse functions.

12. The system of claim 11 wherein the inlet valve, the feed pump, the feed side vent valve, the one or more membrane modules, and the system reject valve are coupled to the membrane modules in series using feed and retentate conduits.

13. The system of claim 12 wherein each of the one or more membrane modules includes an interior space and a filtration membrane, wherein the membrane module includes an inlet coupled to the feed conduit, and wherein a permeate output conduit coupled to the membrane module and arranged to transport permeate passing from the interior space through the filtration membrane, wherein the permeate output conduit is split into a permeate removal conduit and a permeate backpulse conduit.

14. A method of disrupting a layer of membrane foulant on a membrane of one or more membranes of one or more membrane modules from a surface of the membrane of a filtration system, wherein the system includes a feed conduit, a feed pump and a means of regulating the feed pump's speed, a system inlet valve and a means of transitioning the system inlet valve from open to closed and closed to open, a system reject valve and a means of transitioning the system reject valve from open to closed and closed to open, a system feed side vent valve and a means of transitioning the system feed side vent valve from closed to open and open to closed, an integrated control system to enable periodic cycling between filtration and backpulse functions, wherein the inlet valve, the feed pump, the feed side vent valve, the one or more membrane modules, and the system reject valve are coupled to the membrane modules in series using feed and retentate conduits, and wherein each of the one or more membrane modules includes an interior space and a filtration membrane, wherein the membrane module includes an inlet coupled to the feed conduit, and wherein a permeate output conduit coupled to the membrane module and arranged to transport permeate passing from the interior space through the filtration membrane, wherein the permeate output conduit is split into a permeate removal conduit and a permeate backpulse conduit, the method comprising the steps of:
inserting a flexible orifice positioned inline in the permeate removal conduit;
inserting a backpulse check valve in the permeate backpulse conduit; and
periodically backpulsing the membrane modules by:
slowing or stopping the feed pump;
closing the system inlet valve;
closing the system reject valve;
opening the feed side vent valve; and
enabling pressurization of backpulse fluid to permit backpulsing to occur at a desired flow rate and duration within one or more of the conduits.

15. The method of claim 14 for returning the system to filtration mode further comprising the steps of:
disabling the delivery of backpulse fluid to the one or more membrane modules;
closing the feed side vent valve;
opening the system reject valve;
opening the system inlet valve; and
operating the feed pump at its desired speed.

16. The method of claim 14 further comprising the step of monitoring system pressures within one or more of the conduits with one or more pressure sensors for the purpose of initiating the membrane backpulse function.

17. The method of claim 14 further comprising the step of monitoring system temperature and the rate of change at permeate backpressure(s) at one or more membrane modules to evaluate the need to initiate the membrane backpulse function.

18. The method of claim 14, whereby during the filtration operation, the system operates at elevated initial feed at a first membrane module pressure and final retentate at a last membrane module pressure to ensure that sufficient pressure drop exists across each flexible flow orifice to allow each flexible orifice to operate substantially near its maximum desired flow rate.

19. The method of claim 18 whereby the elevated initial feed at the first membrane module pressure is attained by the sum of the feed pump inlet pressure and the pressure generated by the feed pump's operation while the final retentate at the last membrane module pressure is attained by the feed pump inlet pressure alone.

20. The method of claim 14 whereby backpulse fluid is replaced with clean-in-place solution and thereby enabling the membranes contained within the modules to be cleaned through the introduction of clean-in-place fluid using the backpulse flowpath.

21. The method of claim 20 further comprising the step of monitoring system pressures within one or more of the conduits with one or more pressure sensors for the purpose of initiating the membrane cleaning function.

22. The method of claim 20 further comprising the step of monitoring system temperature and the rate of change at permeate backpressure at one or more membrane modules to evaluate the need to initiate the membrane cleaning function.

23. The method of claim 14 further comprising the step to initiate the membrane backpulse function based upon time.

24. The method of claim 14 further comprising the step to initiate the membrane cleaning function based upon time.

25. The method of claim 11 further comprising use of a check valve in place of reject valve having the means of transitioning from open to closed and closed to open.

26. The method of claim 14 further comprising use of a check valve in place of reject valve having the means of transitioning from open to closed and closed to open.
